(19) United States
(12) Patent Application Publication
(10) Pub. No.: US 2023/0242796 A1
(43) Pub. Date: Aug. 3, 2023

(54) ADHESIVE COMPOSITION AND WATER-SOLUBLE ADHESIVE MIXTURE

(71) Applicants: YU-CHUN CHAN, Changhua County (TW); CHING-FANG CHANG, Changhua County (TW)

(72) Inventors: YU-CHUN CHAN, Changhua County (TW); CHING-FANG CHANG, Changhua County (TW)

(21) Appl. No.: 17/893,670

(22) Filed: Aug. 23, 2022

(30) Foreign Application Priority Data
Jan. 28, 2022 (TW) 111104082

(51) Int. Cl. C09J 129/04

(52) U.S. Cl. CPC C09J 129/04

(57) ABSTRACT

An adhesive composition includes an organic adhesive material and a sand. The organic adhesive material includes a water-soluble adhesive and a starch, wherein a weight of the organic adhesive material accounts for 4 wt % to 70 wt % of an overall weight of the adhesive composition, and a weight of the sand accounts for 30 wt % to 96 wt % of the overall weight of the adhesive composition. A water-soluble adhesive mixture includes the adhesive composition and an aqueous solution, which are mixed to form a viscous mixture (i.e., the water-soluble adhesive mixture). The water-soluble adhesive mixture has an adhering function for users to apply to and adhere to a surface of toys, so that the toys could be adhered together to form a toy model. As the water-soluble adhesive could be softened and dissolved when the water-soluble adhesive mixture is immersed in water, the toy model could be disassembled easily.

### BACKGROUND OF THE INVENTION

### Technical Field

The present invention relates generally to an adhesive composition, and more particularly to an adhesive composition and a water-soluble adhesive mixture for applying to toys.

### Description of Related Art

Generally, when children grow to the educational stage, parents usually purchase learning toys for the children to play with, inspiring the children's creative thinking.

There are many types of learning toys for children in the market, wherein building blocks are popular among a majority of customers. As users could directly grasp and engage the different building blocks together, the children could develop creativity during playing by engaging the different building blocks together to build different models, achieving the purpose of entertaining and educating.

However, some building blocks do not provide an engaging function on design. In practice, users have to spread an adhesive on a surface of the building blocks to adhere the different building blocks together. As conventional adhesives spread on an object cannot be dissolved easily, users could only use an adhesive remover to dissolve or soften compositions of the adhesive to disassemble a model, which is made by adhering the different building blocks together, causing inconvenience in disassembling the model. Moreover, the adhesive might remain on the surface of the building blocks, lowering the quality of the building blocks or even making the building blocks non-reusable.

### BRIEF SUMMARY OF THE INVENTION

In view of the above, the primary objective of the present invention is to provide an adhesive composition and a water-soluble adhesive mixture, which could adhere and fix toys together, wherein the water-soluble adhesive mixture could dissolve in water, so that the water-soluble adhesive mixture could be softened and dissolved when immersed in water, allowing the toys that are adhered together to be disassembled easily and conveniently.

The present invention provides the adhesive composition including an organic adhesive material and a sand. The organic adhesive material includes a water-soluble adhesive and a starch, wherein a weight of the organic adhesive material accounts for 4 wt % to 70 wt % of an overall weight of the adhesive composition, and a weight of the sand accounts for 30 wt % to 96 wt % of the overall weight of the adhesive composition.

The present invention also provides a water-soluble adhesive mixture including an adhesive composition and an aqueous solution. The adhesive composition includes an organic adhesive material and a sand. The organic adhesive material includes a water-soluble adhesive and a starch. A weight of the organic adhesive material accounts for 4 wt % to 70 wt % of an overall weight of the adhesive composition, and a weight of the sand accounts for 30 wt % to 96 wt % of the overall weight of the adhesive composition. The aqueous solution and adhesive composition are mixed to form a viscous mixture (i.e., the water-soluble adhesive mixture), wherein an addition of the aqueous solution is equal to 33 wt % to 99 wt % of the overall weight of the adhesive composition.

With the aforementioned design, the water-soluble adhesive mixture could imitate a cement and have an adhering function for users to apply to and adhere to a surface of the toys, such as building blocks or parts, so that the toys could be adhered together to form a model. As the water-soluble adhesive of the water-soluble adhesive mixture could dissolve in water, the water-soluble adhesive could be softened and dissolved when the water-soluble adhesive mixture is immersed in water, weakening the adhesion of the water-soluble adhesive mixture and allowing the model, which is made by adhering different toys together, to be disassembled easily. Additionally, the water-soluble adhesive mixture could be directly washed away with water and would not remain on the surface of the toys, maintaining the quality of the toys.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a bar chart illustrating the result of the drying experiment carried out among the control groups and the experimental groups of the water-soluble adhesive mixture of the present invention;

FIG. 2 is a bar chart illustrating the result of the drying experiment carried out among the experimental groups with different compositions of the water-soluble adhesive mixture of the present invention;

FIG. 3 is a bar chart illustrating the result of the dissolution experiment carried out among the control groups and the experimental groups of the water-soluble adhesive mixture of the present invention; and

FIG. 4 is a bar chart illustrating the result of the dissolution experiment carried out among the experimental groups with different compositions of the water-soluble adhesive mixture of the present invention.

### DETAILED DESCRIPTION OF THE INVENTION

The present invention provides an adhesive composition including an organic adhesive material and a sand.

The organic adhesive material includes a water-soluble adhesive and a starch. A weight of the organic adhesive material accounts for 4 wt % to 70 wt % of an overall weight of the adhesive composition, wherein the water-soluble adhesive is a hydrolyzed polyvinyl alcohol (PVA), which is a non-toxic macromolecular material and does not cause skin irritation. In practice, the water-soluble adhesive and the starch could be packed separately and then mixed before using, or could be mixed and packed together in advance.

In an embodiment, a degree of hydrolysis of the water-soluble adhesive ranges between 85 mole % and 99.5 mole %, and a viscosity of the water-soluble adhesive at 25° C. ranges between 5 cps and 50 cps. In the current embodiment, the water-soluble adhesive includes a first hydrolyzed polyvinyl alcohol, a second hydrolyzed polyvinyl alcohol, and a third hydrolyzed polyvinyl alcohol. A degree of hydrolysis of the first hydrolyzed polyvinyl alcohol, a degree of hydrolysis of the second hydrolyzed polyvinyl alcohol, and a degree of hydrolysis of the third hydrolyzed polyvinyl alcohol are different from one another, wherein the degree of hydrolysis of the first hydrolyzed polyvinyl alcohol is larger than the degree of hydrolysis of the second hydrolyzed polyvinyl alcohol and the degree of hydrolysis of third hydrolyzed polyvinyl alcohol. In the current embodiment, the degree of hydrolysis of the first hydrolyzed polyvinyl alcohol ranges between 98 mole % and 99.5 mole %, the degree of hydrolysis of the second hydrolyzed polyvinyl alcohol ranges between 86 mole % and 89 mole %, and the degree of hydrolysis of the third hydrolyzed polyvinyl alcohol ranges between 86 mole % and 89 mole %. As shown in the description above, the first hydrolyzed polyvinyl alcohol is a fully hydrolyzed polyvinyl alcohol, and both the second hydrolyzed polyvinyl alcohol and the third hydrolyzed polyvinyl alcohol are partially hydrolyzed polyvinyl alcohol.

The term “degree of hydrolysis” in the description indicates a degree of hydrophobic acetate groups of polyvinyl alcohol being replaced by hydrophilic groups, wherein the larger the degree of hydrolysis of the polyvinyl alcohol, the greater the tendency of the polyvinyl alcohol to bind with hydrophilic substances and the greater the adhesion of the polyvinyl alcohol. As the partially hydrolyzed polyvinyl alcohol retains a part of the hydrophobic groups, the partially hydrolyzed polyvinyl alcohol has greater adhesion to hydrophobic substances than the fully hydrolyzed polyvinyl alcohol. Moreover, a viscosity of the first hydrolyzed polyvinyl alcohol, a viscosity of the second hydrolyzed polyvinyl alcohol, and a viscosity of the third hydrolyzed polyvinyl alcohol are different from one another, wherein the viscosity of the first hydrolyzed polyvinyl alcohol is larger than the viscosity of the second hydrolyzed polyvinyl alcohol, and is smaller than the viscosity of the third hydrolyzed polyvinyl alcohol. In the current embodiment, the viscosity of the first hydrolyzed polyvinyl alcohol at 25° C. ranges between 25 cps and 30 cps, the viscosity of the second hydrolyzed polyvinyl alcohol at 25° C. ranges between 5 cps and 6 cps, and the viscosity of the third hydrolyzed polyvinyl alcohol at 25° C. ranges between 44 cps and 50 cps.

In an embodiment, a weight of the water-soluble adhesive accounts for 2.5 wt % to 42 wt % of an overall weight of the adhesive composition. In another embodiment, the weight of the water-soluble adhesive accounts for 5 wt % to 10 wt % of the overall weight of the adhesive composition, wherein a weight of the first hydrolyzed polyvinyl alcohol accounts for 1 wt % to 2 wt % of the overall weight of the adhesive composition, a weight of the second hydrolyzed polyvinyl alcohol accounts for 2.5 wt % to 5 wt % of the overall weight of the adhesive composition, and a weight of the third hydrolyzed polyvinyl alcohol accounts for 1.5 wt % to 3 wt % of the overall weight of the adhesive composition. It is worth mentioning that the weight of the water-soluble adhesive would affect the adhesive function of the adhesive composition as discovered in a viscosity experiment on the adhesive composition, wherein if the weight of the water-soluble adhesive is greater than 42 wt % of the overall weight of the adhesive composition, the adhesive composition would severely agglomerate and could not be used normally; if the weight of the water-soluble adhesive is less than 2.5 wt % of the overall weight of the adhesive composition, a viscosity of the adhesive composition would be too low to be used normally; thereby the adhesive composition could provide a better adhesion only when the weight of the water-soluble adhesive accounts for a particular weight percentage range of the overall weight of the adhesive composition.

The starch is a natural polymer and includes a pregelatinized starch, a natural starch, a dextrin, and a cooked glutinous rice flour, or a combination thereof. The natural starch could be, but not limited to, soybean flour or Job's tears powder. The dextrin could be, but not limited to, a maltodextrin, an industrial dextrin, or a polydextrose. The benefit of using the pregelatinized starch is that the pregelatinized starch is water-soluble and has a high viscosity and expansibility, allowing the adhesive composition to be mixed with water to form an adhesive mixture having a great adhesion.

Experiments on the water-soluble adhesive of the present embodiment discovered that although the water-soluble adhesive could be solely mixed with the sand for adhesive use, precipitation would be caused by the uneven mixing of the water-soluble adhesive and the sand; adding the starch could increase the viscosity of the water-soluble adhesive and facilitate to mix the water-soluble adhesive and the sand evenly. A weight of the starch accounts for 1.5 wt % to 28 wt % of the overall weight of the adhesive composition. In an embodiment, the weight of the starch accounts for 3 wt % to 7 wt % of the overall weight of the adhesive composition, wherein the starch at least includes a first starch and a second starch. In the current embodiment, the first starch includes the maltodextrin, and the second starch includes a pregelatinized corn starch, wherein a content of the first starch is larger than a content of the second starch. In an embodiment, the starch further includes a third starch including a pregelatinized tapioca starch, and a content of the third starch is equal to the content of the first starch, wherein a weight of the first starch accounts for 1.11 wt % to 2.22 wt % of the overall weight of the adhesive composition, a weight of the second starch accounts for 1.11 wt % to 2.22 wt % of the overall weight of the adhesive composition, and a weight of the third starch accounts for 1.11 wt % to 2.22 wt % of the overall weight of the adhesive composition. In another embodiment, the first starch could be, but not limited to, replaced with the cooked glutinous rice flour, at that time the content of the first starch is less than the content of the second starch and the content of the third starch, and the content of the second starch is equal to the content of the third starch. In other embodiments, the content and the type of the starch could be adjusted depending on requirements.

It is worth mentioning that as the maltodextrin powder has a large volume and a small weight, adding the maltodextrin could not only increase a volume of the adhesive composition, but also facilitate to mix the water-soluble adhesive and the sand evenly, relieving the separation between the water-soluble adhesive and the sand. Additionally, when the adhesive composition is mixed with water, the starch could increase the viscosity and the stirring feeling of the adhesive composition, allowing the adhesive composition to be effectively spread and adhere to a surface of an object.

The sand is a silica sand and mainly serves as a framing structure of the adhesive composition. A weight of the sand changes with a content of the water-soluble adhesive and the content of the starch, and accounts for 30 wt % to 96 wt % of the overall weight of the adhesive composition, wherein a grain size of the sand ranges between 70 mesh and 200 mesh. In an embodiment, the weight of the sand accounts for 83 wt % to 92 wt % of the overall weight of the adhesive composition, and the grain size of the sand ranges between 80 mesh and 120 mesh. In practice, a sum of the weight percentage of the organic adhesive material and the weight percentage of the sand is less than or equal to 100 wt % of the adhesive composition.

An another embodiment of the present invention provides a water-soluble adhesive mixture, including the aforementioned adhesive composition and an aqueous solution. The aqueous solution and the adhesive composition are mixed to form a viscous mixture (i.e., the water-soluble adhesive mixture), which could be spread on a surface of toys to adhere the toys together. In the current embodiment, the toys could be, but not limited to, building blocks, model bricks, or model parts, as long as the surface of the toys could be provided for the water-soluble adhesive mixture to be spread and adhered on.

An addition of the aqueous solution is equal to 33 wt % to 99 wt % of the overall weight of the adhesive composition, wherein a ratio of the overall weight of the adhesive composition to a weight of the aqueous solution could be adjusted depending on requirements. However, the current embodiment discovers that if the addition of the aqueous solution is above 99 wt % of the overall weight of the adhesive composition, a mobility of the water-soluble adhesive mixture would be increased excessively, thereby an overall viscosity of the water-soluble adhesive mixture would be decreased, making the water-soluble adhesive mixture unable to normally adhere on the surface of the toys.

It is worth mentioning that the starch of the adhesive composition could not only increase the overall viscosity of the water-soluble adhesive mixture, but also increase a drying rate of the water-soluble adhesive mixture. Additionally, the grain size of the sand of the adhesive composition would affect a structural strength of the water-soluble adhesive mixture, wherein if the grain size of the sand is above 200 mesh, the mobility of the water-soluble adhesive mixture would be increased as the grain size of the sand is too small, weakening the adhering function of the water-soluble adhesive mixture to adhere on the surface of the toys, thereby making a thickness of the water-soluble adhesive mixture formed between the two adjacent toys too small. As a result, the structural strength of the water-soluble adhesive mixture would be decreased after drying, making the water-soluble adhesive mixture disintegrate easily. However, if the grain size of the sand is below 70 mesh, an obvious granular feeling of the water-soluble adhesive mixture would be resulted as the grain size of the sand is too large, lowering the using quality of the water-soluble adhesive mixture. As a result, the thickness of the water-soluble adhesive mixture formed between the two adjacent toys would be too large, affecting the outlook of the toys.

In order to thoroughly illustrate the primary objective, features, and functions of the present invention, the formula of the adhesive composition of the present invention would be illustrated in the below description. Moreover, in order to illustrate that the water-soluble adhesive mixture of the current embodiment has a better drying rate and could be dissolved in water, drying experiments and dissolving experiments are carried out on the water-soluble adhesive mixture made of the adhesive composition.

1. Experimental Materials

The experimental materials include five hydrolyzed polyvinyl alcohols, four starches, and a sand.

The five hydrolyzed polyvinyl alcohols include a polyvinyl alcohol #BF-17S grade, a polyvinyl alcohol #BP-05S grade, a polyvinyl alcohol #BP-24S grade, a polyvinyl alcohol #BP-20S grade, and a polyvinyl alcohol #BP-17S grade, wherein the polyvinyl alcohol #BF-17S grade, the polyvinyl alcohol #BP-05S grade, the polyvinyl alcohol #BP-24S grade, and the polyvinyl alcohol #BP-20S grade are produced by the Chang Chun Petrochemical Co., Ltd. The polyvinyl alcohol #BF-17S grade is the first hydrolyzed polyvinyl alcohol of the present invention, the polyvinyl alcohol #BP-05S grade is the second hydrolyzed polyvinyl alcohol of the present invention, and the polyvinyl alcohol #BP-24S grade is the third hydrolyzed polyvinyl alcohol. Both a degree of hydrolysis of the polyvinyl alcohol #BP-20S grade and a degree of hydrolysis of the polyvinyl alcohol #BP-17S range between 86 mole % and 89 mole %, wherein a viscosity of the polyvinyl alcohol #BP-20S grade at 25° C. ranges between 27 cps and 33 cps, and a viscosity of the polyvinyl alcohol #BP-17S grade at 25° C. ranges between 21 cps and 26 cps, so that both the viscosity of the polyvinyl alcohol #BP-20S grade at 25° C. and the viscosity of the polyvinyl alcohol #BP-17S grade at 25° C. range between the viscosity of the polyvinyl alcohol #BP-20S grade at 25° C. and the viscosity of the hydrolyzed polyvinyl alcohol #BP-05S grade.

The four starches include the maltodextrin, the pregelatinized tapioca starch, the pregelatinized corn starch, and the cooked glutinous rice flour, wherein the maltodextrin, the pregelatinized tapioca starch, and the pregelatinized corn starch are produced by the Zih Mao Enterprise Co., Ltd. The sand is mainly made of silica sand.

2. Compositions and Formulas

The compositions and the formulas of six control groups 1 to 6 and three experimental groups 1 to 3 of the current embodiment are listed below:

The control group 1 includes 3.33 wt % of the polyvinyl alcohol #BF-17S grade, 13.33 wt % of the polyvinyl alcohol #BP-05S grade, and 83.34 wt % of the sand.

The control group 2 includes 8.33 wt % of the polyvinyl alcohol #BP-05S grade, 5.0 wt % of the polyvinyl alcohol #BP-24S grade, 3.33 wt % of the polyvinyl alcohol #BF-17S grade, and 83.34 wt % of the sand.

The control group 3 includes 8.33 wt % of the polyvinyl alcohol #BP-05S grade, 3.33 wt % of the polyvinyl alcohol #BP-17S grade, 3.33 wt % of the polyvinyl alcohol #BP-20S grade, 1.67 wt % of the polyvinyl alcohol #BP-24S grade, and 83.34 wt % of the sand.

The control group 4 includes 11.08 wt % of the maltodextrin, 5.58 wt % of the pregelatinized corn starch, and 83.34 wt % of the sand.

The control group 5 includes 5.56 wt % of the maltodextrin, 5.55 wt % of the pregelatinized tapioca starch, 5.58 wt % of the pregelatinized corn starch, and 83.34 wt % of the sand.

The control group 6 includes 4.42 wt % of the maltodextrin, 3.33 wt % of the pregelatinized tapioca starch, 3.33 wt % pregelatinized corn starch, 5.58 wt % of the cooked glutinous rice flour, and 83.34 wt % of the sand.

The experimental group 1 includes 5 wt % of the polyvinyl alcohol #BP-05S grade, 3 wt % of the polyvinyl alcohol #BP-24S grade, 2 wt % of the polyvinyl alcohol #BF-17S grade, 2.25 wt % of the maltodextrin, 2.25 wt % of the pregelatinized tapioca starch, 2.16 wt % of the pregelatinized corn starch, and 83.34 wt % of the sand.

The experimental group 2 includes 5 wt % of the polyvinyl alcohol #BP-05S grade, 3 wt % of the polyvinyl alcohol #BP-24S grade, 2 wt % of the polyvinyl alcohol #BF-17S grade, 2.25 wt % of the pregelatinized tapioca starch, 2.25 wt % of the pregelatinized corn starch, 2.16 wt % of the cooked glutinous rice flour, and 83.34 wt % of the sand.

The experimental group 3 includes 5 wt % of the polyvinyl alcohol #BP-05S grade, 3 wt % of the polyvinyl alcohol #BP-24S grade, 2 wt % of the polyvinyl alcohol #BF-17S grade, 4.33 wt % of the maltodextrin, 2.33 wt % of the pregelatinized corn starch, and 83.34 wt % of the sand.

Then, 100 g of a mixture is poured out from each of the control groups 1 to 6 and each of the experimental groups 1 to 3 to be respectively mixed with 66 g of the aqueous solution to produce the water-soluble adhesive mixture. After that, 30 g of the water-soluble adhesive mixture of each of the control groups 1 to 6 and each of the experimental groups 1 to 3 is poured out for a drying experiment.

It is worth mentioning that each of the control groups 1 to 6 and each of the experimental groups 1 to 3 include different materials, thereby including a different water content. The water content of each of the control groups 1 to 6 and each of the experimental groups 1 to 3 is measured in advance, wherein the water content of the control group 1 is about 12 g, the water content of the control group 2 is about 12 g, the water content of the control group 3 is about 11 g, the water content of the control group 4 is about 12 g to 13 g, the water content of the control group 5 is about 12 g to 13 g, the water content of the control group 6 is about 10 g to 11 g, the water content of the experimental group 1 is about 11 g to 12 g, the water content of the experimental group 2 is about 13 g to 14 g, and the water content of the experimental group 3 is about 14 g to 15 g. As the water contents of each of the control groups 1 to 6 and each of the experimental groups 1 to 3 would affect a weight of the water-soluble adhesive mixture at the final drying, the weight of each of the control groups 1 to 6 and each of the experimental groups 1 to 3 at the final drying are different.

3. Result of the Drying Experiment

The drying experiment is respectively carried out on the control groups 1 to 6 and the experimental groups 1 to 3, wherein the experimental conditions of the drying experiment include: the control groups 1 to 6 and the experimental groups 1 to 3 are respectively placed on a Petri dish and are left in an environment at 25° C. room temperature and 56% humidity for natural drying, then the change of the weight of each of the water-soluble adhesive mixtures are observed and measured at 12-hour intervals, and the total experimental time is 72 hours. The result of the drying experiment is shown in Table 1 below.

TABLE 1
A table showing the drying record of the control groups 1 to 6 and the experimental groups 1 to 3

| Drying time (hr) | 0 | 12 | 24 | | 36 | | 48 | | 60 | | 72 | |
|---|---|---|---|---|---|---|---|---|---|---|---|---|
| Control group 1 | 30 g | 26.35 g | 23.08 | g | 19.58 | g | 18.7 | g | 18.39 | g | 18.22 | g |
| Control group 2 | 30 g | 25.49 g | 22.4 | g | 19.16 | g | 18.39 | g | 18.1 | g | 18.02 | g |
| Control group 3 | 30 g | 26.25 g | 23.18 | g | 20.32 | g | 19.5 | g | 19.13 | g | 18.99 | g |
| Control group 4 | 30 g | 26.11 g | 22.96 | g | 18.51 | g | 17.31 | g | 17.26 | g | 17.26 | g |
| Control group 5 | 30 g | 24.58 g | 21.76 | g | 19.21 | g | 18.18 | g | 17.83 | g | 17.81 | g |
| Control group 6 | 30 g | 29.94 g | 23.93 | g | 21.13 | g | 20.08 | g | 19.78 | g | 19.76 | g |
| Experimental group 1 | 30 g | 25.74 g | 21.67 | g | 19.17 | g | 18.65 | g | 18.6 | g | 18.6 | g |
| Experimental group 2 | 30 g | 24.28 g | 20.94 | g | 18.15 | g | 17.03 | g | 16.81 | g | 16.76 | g |
| Experimental group 3 | 30 g | 24.28 g | 20.94 | g | 16.8 | g | 15.83 | g | 15.59 | g | 15.55 | g |

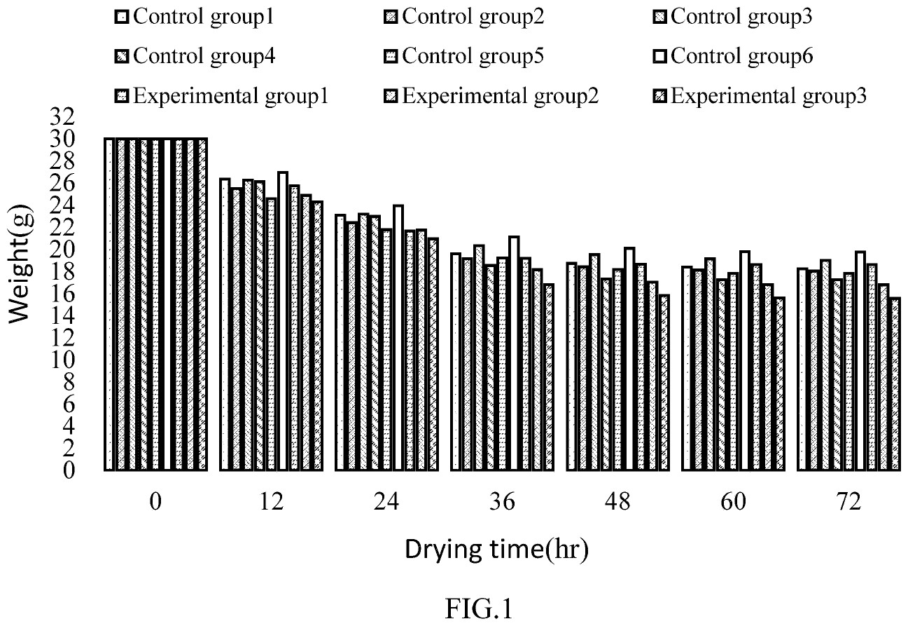

As shown in Table 1 and FIG. 1, an obvious change of the weight of each of the control groups 1 to 6 and each of the experimental groups 1 to 3 is measured at the drying time of 24 hours, wherein general customers could determine a drying status and an adhesion of each of the water-soluble adhesive mixtures as a dried status after the drying time of 24 hours, and an inner portion of each of the water-soluble adhesive mixtures that is wet does not affect the adhesion and the playing experience in practice. Besides, at the drying time of 60 hours and 72 hours, the decrease of the weight of the experimental group 2 relative to the initial weight (i.e., 30 g) and the decrease of the weight of the experimental group 3 relative to the initial weight (i.e., 30 g) are the most obvious compared to the control groups 1 to 6 and the experimental group 1, showing that the experimental group 2 and the experimental group 3 have the larger water content than the control groups 1 to 6 and the experimental group 1. Additionally, during the drying time between 24 hours and 72 hours, the water contents of the experimental groups 1 to 3 are similar, showing that there is no obvious difference in the drying rates among the experimental groups 1 to 3, and the experimental groups 1 to 3 almost reach a fully dried status at the drying time of 72 hours.

4. Determination of Whether the Weight of the Experimental Groups 1 to 3 would Affect the Drying Rate

In the current experiment, the experimental groups 1 to 3 are divided into nine experimental groups 1-1, 1-2, 1-3, 2-1, 2-2, 2-3, 3-1, 3-2, and 3-3, wherein the composition and the formula of each of the experimental groups 1-1 to 3-3 are listed below.

The experimental group 1-1 includes 1.67 wt % of the polyvinyl alcohol #BP-05S grade-1 wt % of the polyvinyl alcohol #BP-24S grade, 0.66 wt % of the polyvinyl alcohol #BF-17S grade, 0.75 wt % of the maltodextrin, 0.75 wt % of the pregelatinized tapioca starch, 0.72 wt % of the pregelatinized corn starch, and 94.45 wt % of the sand.

The experimental group 1-2 includes 5 wt % of the polyvinyl alcohol #BP-05S grade, 3 wt % of the polyvinyl alcohol #BP-24S grade, 2 wt % of the polyvinyl alcohol #BF-17S grade, 2.25 wt % of the maltodextrin, 2.25 wt % of the pregelatinized tapioca starch, 2.16 wt % of the pregelatinized corn starch, and 83.34 wt % of the sand.

The experimental group 1-3 includes 15 wt % of the polyvinyl alcohol #BP-05S grade, 9 wt % of the polyvinyl alcohol #BP-24S grade, 6 wt % of the polyvinyl alcohol #BF-17S grade, 6.75 wt % of the maltodextrin, 6.75 wt % of the pregelatinized tapioca starch, 6.48 wt % of the pregelatinized corn starch, and 50.02 wt % of the sand.

The experimental group 2-1 includes 1.67 wt % of the polyvinyl alcohol #BP-05S grade, 1 wt % of the polyvinyl alcohol #BP-24S grade, 0.66 wt % of the polyvinyl alcohol #BF-17S grade, 0.75 wt % of the pregelatinized tapioca starch, 0.75 wt % of the pregelatinized corn starch, 0.72 wt % of the cooked glutinous rice flour, and 94.45 wt % of the sand.

The experimental group 2-2 includes 5 wt % of the polyvinyl alcohol #BP-05S grade, 3 wt % of the polyvinyl alcohol #BP-24S grade, 2 wt % of the polyvinyl alcohol #BF-17S grade, 2.25 wt % of the pregelatinized tapioca starch, 2.25 wt % of the pregelatinized corn starch, 2.16 wt % of the cooked glutinous rice flour, and 83.34 wt % of the sand.

The experimental group 2-3 includes 15 wt % of the polyvinyl alcohol #BP-05S grade, 9 wt % of the polyvinyl alcohol #BP-24S grade, 6 wt % of the polyvinyl alcohol #BF-17S grade, 6.75 wt % of the pregelatinized tapioca starch, 6.75 wt % of the pregelatinized corn starch, 6.48 wt % of the cooked glutinous rice flour, and 50.02 wt % of the sand.

The experimental group 3-1 includes 1.67 wt % of the polyvinyl alcohol #BP-05S grade, 1 wt % of the polyvinyl alcohol #BP-24S grade, 0.66 wt % of the polyvinyl alcohol #BF-17S grade, 1.44 wt % of the maltodextrin, 0.78 wt % of the pregelatinized corn starch, 94.45 wt % of the sand.

The experimental group 3-2 includes 5 wt % of the polyvinyl alcohol #BP-05S grade, 3 wt % of the polyvinyl alcohol #BP-24S grade, 2 wt % of the polyvinyl alcohol #BF-17S grade, 4.33 wt % of the maltodextrin, 2.33 wt % of the pregelatinized corn starch, and 83.34 wt % of the sand.

The experimental group 3-3 includes 15 wt % of the polyvinyl alcohol #BP-05S grade, 9 wt % of the polyvinyl alcohol #BP-24S grade, 6 wt % of the polyvinyl alcohol #BF-17S grade, 12.99 wt % of the maltodextrin, 6.99 wt % of the pregelatinized corn starch, and 50.02 wt % of the sand.

Similarly, 100 g of a mixture is poured out from each of the experimental groups 1-1, 1-2, 1-3, 2-1, 2-2, 2-3, 3-1, 3-2, and 3-3, wherein 33 g of the aqueous solution is respectively added into the experimental group 1-1, 2-1, and 3-1, 66 g of the aqueous solution is respectively added into the experimental group 1-2, 2-2, and 3-2, and 99 g of the aqueous solution is respectively added into the experimental group 1-3, 2-3, and 3-3, thereby producing the water-soluble adhesive mixture of each of the experimental groups 1-1, 1-2,1-3, 2-1, 2-2, 2-3, 3-1, 3-2, and 3-3, and afterwards 30 g of the water-soluble adhesive mixture of the experimental groups 1-1, 1-2, 1-3, 2-1, 2-2, 2-3, 3-1, 3-2, and 3-3 is respectively poured out for a drying experiment.

Then, a water content of the water-soluble adhesive mixture of each of the experimental groups 1-1, 1-2, 1-3, 2-1, 2-2, 2-3, 3-1, 3-2, and 3-3 is measured in advance, wherein the water content of the experimental group 1-1 is about 9 g to 10 g, the water content of the experimental group 1-2 is about 12 g, the water content of the experimental group 1-3 is about 14 g, the water content of the experimental group 2-1 is about 8 g, the water content of the experimental group 2-2 is about 13 g to 14 g, the water content of the experimental group 2-3 is about 13 to 14 g, the water content of the experimental group 3-1 is about 9 g to 10 g, the water content of the experimental group 3-2 is about 14 g to 15 g, and the water content of the experimental group 3-3 is about 14 g to 15 g. As the water content of each of the experimental groups 1-1 to 3-3 would affect a weight of the water-soluble adhesive mixture of each of the experimental groups 1-1 to 3-3 at the final drying, the weight of each of the experimental groups 1-1 to 3-3 at the final drying are different.

The drying experiment is respectively carried out on the experimental groups 1-1, 1-2,1-3, 2-1, 2-2, 2-3, 3-1, 3-2, and 3-3, wherein the experimental conditions of the drying experiment are the same as that of the aforementioned drying experiment including: each of the experimental groups 1-1 to 3-3 is placed on a Petri dish and is left in an environment at 25° C. room temperature and 56% humidity for natural drying, then the change of the weight of each of the water-soluble adhesive mixtures is observed and measured at 12-hour intervals, and the total experimental time is 72 hours. The result of the drying experiment is shown in Table 2 below.

TABLE 2
A table showing the drying record of the experimental groups 1-1 to 3-3

| Drying time (hr) | 0 | 12 | 24 | 36 | | 48 | | 60 | | 72 | |
|---|---|---|---|---|---|---|---|---|---|---|---|
| Experimental group 1-1 | 30 g | 26.46 g | 23.52 g | 21.85 | g | 21.54 | g | 21.53 | g | 21.51 | g |
| Experimental group 1-2 | 30 g | 25.74 g | 21.67 g | 19.17 | g | 18.65 | g | 18.6 | g | 18.6 | g |
| Experimental group 1-3 | 30 g | 25.88 g | 23.32 g | 20.1 | g | 18.3 | g | 17.08 | g | 16.42 | g |
| Experimental group 2-1 | 30 g | 26.63 g | 23.84 g | 22.3 | g | 22.03 | g | 22.02 | g | 22 | g |
| Experimental group 2-2 | 30 g | 24.28 g | 20.94 g | 18.15 | g | 17.03 | g | 16.81 | g | 16.76 | g |
| Experimental group 2-3 | 30 g | 25.99 g | 23.39 g | 20.46 | g | 18.78 | g | 17.52 | g | 16.82 | g |
| Experimental group 3-1 | 30 g | 26.55 g | 23.61 g | 22.15 | g | 21.75 | g | 21.72 | g | 21.7 | g |
| Experimental group 3-2 | 30 g | 24.28 g | 20.94 g | 16.8 | g | 15.83 | g | 15.59 | g | 15.55 | g |
| Experimental group 3-3 | 30 g | 24.96 g | 21.96 g | 18.89 | g | 17.39 | g | 16.5 | g | 16.02 | g |

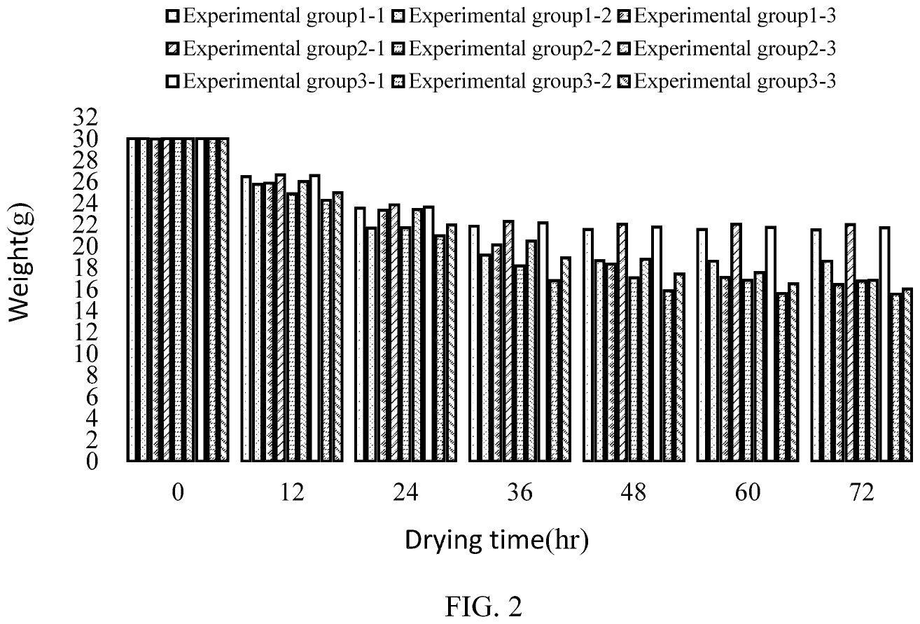

As shown in Table 2 and FIG. 2, at the drying time of 60 hours and 72 hours, the decrease of the weight of the experimental groups 1-1, 2-1, and 3-1 relative to the initial weight (i.e., 30 g) are the smallest among the experimental groups 1-1 to 3-3, showing that the water content of the experimental groups 1-1, 2-1, and 3-1 are smaller compared to the water content of the other experimental groups. As the content of the starch of the experimental groups 1-1, 2-1, and 3-1 are smaller than the content of the starch of the other experimental groups, and the content of the water-soluble adhesive of the experimental groups 1-1, 2-1, and 3-1 are smaller than the content of the water-soluble adhesive of the other experimental groups, the drying rate of the experimental groups 1-1, 2-1, and 3-1 are faster compared to the other experimental groups. However, a viscosity of the water-soluble adhesive mixture of the experimental groups 1-1, 2-1, and 3-1 are too small, making the water-soluble adhesive mixture spill easily after being spread on the surface of the object. As a result, the water-soluble adhesive mixture of the experimental groups 1-1, 2-1, and 3-1 could not be spread evenly on the surface of the object, and the strength of the water-soluble adhesive mixture of the experimental groups 1-1, 2-1, and 3-1 after drying is too small, thereby could not be used for adhesive use.

Additionally, the content of the starch of the experimental groups 1-3, 2-3, and 3-3 and the content of the water-soluble adhesive of the experimental groups 1-3, 2-3, and 3-3 are too large, making the water content of the water-soluble adhesive mixture of the experimental groups 1-3, 2-3, and 3-3 too large. Compared to the other experimental groups, the water-soluble adhesive of the experimental groups 1-3, 2-3, and 3-3 are too viscous and hard to be evenly spread on the surface of the object, greatly decreasing the drying rate of the experimental groups 1-3, 2-3, and 3-3. Compared to the other experimental groups, the drying rate of the experimental groups 1-2, 2-2, and 3-2 are the most suitable.

5. Dissolving Experiment and Result of the Dissolving Rate

The current experiment explores a dissolving rate in water of the control groups 1 to 6 and the experimental groups 1 to 3.

The experimental conditions of the dissolving experiment include: the water-soluble adhesive mixtures of each of the control groups 1 to 6 and the water-soluble adhesive mixtures of each of the experimental groups 1 to 3 are left in a water tank, is disposed above a bottom of the water tank by a distance, and is immersed by water in the water tank. The time that the water-soluble adhesive mixture starts disintegrating is recorded as the time recorded point of starting dissolution. The result of the dissolving experiment is shown in Table 3 below.

TABLE 3
A table showing the dissolving record of the control
groups 1 to 6 and the experimental groups 1 to 3

| | Time of starting | |
|---|---|---|
| | dissolution (min) | |
| Control group 1 | 21 | (second) |
| Control group 2 | 131 | (min) |
| Control group 3 | 285 | (min) |
| Control group 4 | 2 | (min) |
| Control group 5 | 30 | (min) |
| Control group 6 | 13 | (min) |
| Experimental group 1 | 63 | (min) |
| Experimental group 2 | 28 | (min) |
| Experimental group 3 | 45 | (min) |

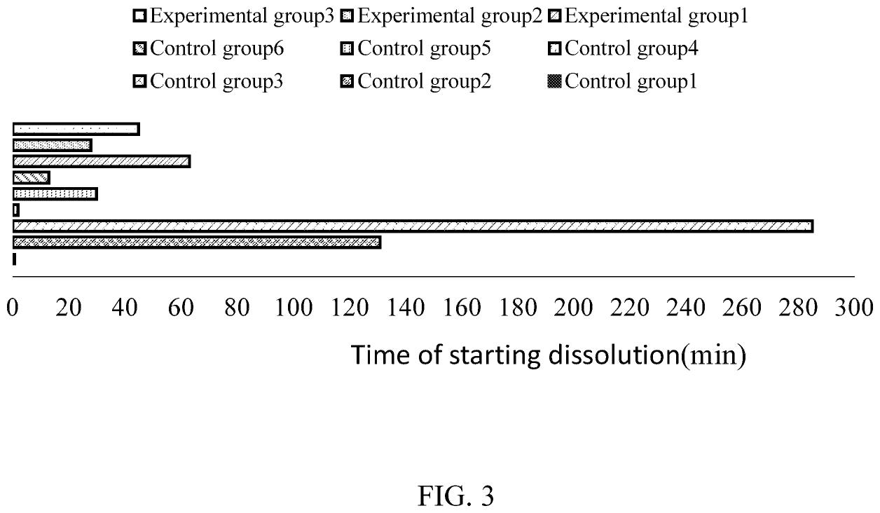

As shown in Table 3 and FIG. 3, the time of starting dissolution of the control group 1 is too fast, showing that the control group 1 disintegrates too quickly upon experiencing water, such that the control group 1 could not provide the adhesion function. The grades of the polyvinyl alcohol included in the control group 2 and the grades of the polyvinyl alcohol included in the control group 3 are hard to dissolve in water, thereby the time of start dissolution of the control group 2 and the time of start dissolution of the control group 3 are too slow. As the control groups 4 to 6 are solely made of different starches, the control groups 4 to 6 dissolve in water more quickly compared to the other control groups and the experimental groups 1 to 3, thereby are not suitable for adhering to the object. The times of starting dissolution of the experimental groups 1 to 3 range between 30 min and 60 min, wherein the time of starting dissolution of the experimental group 2 is the fastest among the experimental groups 1 to 3.

6. Determination of Whether the Weight of the Experimental Groups 1 to 3 would Affect the Dissolving Rate

The current experiment makes use of the aforementioned experimental groups 1-1, 1-2,1-3, 2-1, 2-2, 2-3, 3-1, 3-2, and 3-3.

The dissolving experiment is respectively carried out on the experimental groups 1-1, 1-2,1-3, 2-1, 2-2, 2-3, 3-1, 3-2, and 3-3, wherein the experimental conditions of the dissolving experiment are the same as that of the aforementioned dissolving experiment including: the water-soluble adhesive mixtures of each of the experimental group 1-1 to 3-3 is left in a water tank, is disposed above a bottom of the water tank by a distance, and is immersed by water in the water tank. The time that the water-soluble adhesive mixture starts disintegrating is recorded as the time recorded point of starting dissolution. The result of the dissolving experiment is shown in Table 4 below.

TABLE 3
A table showing the dissolving record
of the experimental groups 1-1 to 3-3

| | Time of starting | |
|---|---|---|
| | dissolution (min) | |
| Experimental group 1-1 | 3 | (min) |
| Experimental group 1-2 | 63 | (min) |
| Experimental group 1-3 | 204 | (min) |
| Experimental group 2-1 | 3 | (min) |
| Experimental group 2-2 | 28 | (min) |
| Experimental group 2-3 | 155 | (min) |
| Experimental group 3-1 | 32 | (min) |
| Experimental group 3-2 | 45 | (min) |
| Experimental group 3-3 | 225 | (min) |

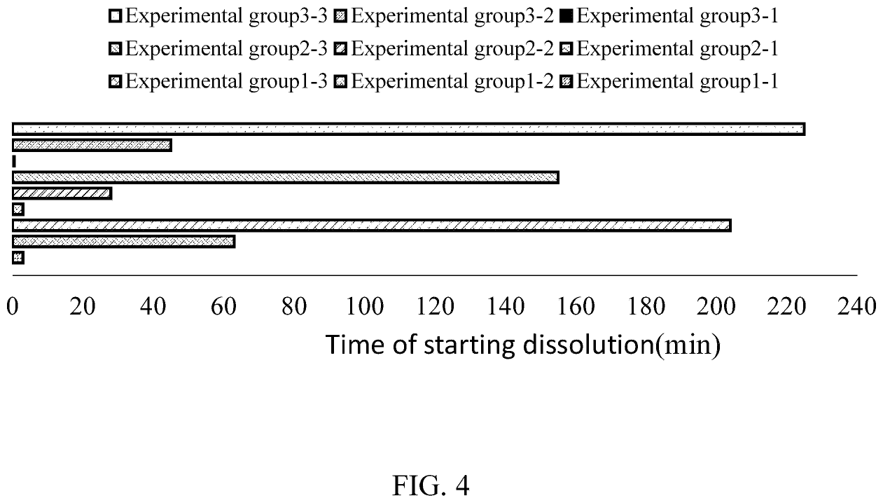

As shown in Table 4 and FIG. 4, the time of starting dissolution of the experimental groups 1-1, 2-1, and 3-1 are too fast, and could not provide the adhesion function. The content of the starch of the experimental groups 1-3, 2-3, and 3-3 and the content of the water-soluble adhesive of the experimental groups 1-3, 2-3, and 3-3 are too large, making the experimental groups 1-3, 2-3, and 3-3 hard to dissolve in water, thereby greatly increasing the time of starting dissolution of the experimental groups 1-3, 2-3, and 3-3. Compared to the other experimental groups, the dissolving rate of the experimental groups 1-2, 2-2, and 3-2 are the most suitable.

It is worth mentioning that factors would be taken into consideration integrally before determining the best formula for the product, including the drying rate, the dissolving rate, whether the water-soluble adhesive mixture is easy to be washed away, whether the water-soluble adhesive mixture would easily remain on the surface of the object after washing, the adhesion of the water-soluble adhesive mixture and the viscosity of the water-soluble adhesive mixture, whether the water-soluble adhesive mixture is easy to be evenly spread on the surface of the object, and whether the compositions of the water-soluble adhesive mixture are durable and could be stored for a long time. Although the time of starting dissolution of the experimental group 2-2 is faster than the time of starting dissolution of the experimental group 1-2 and the time of starting dissolution of the experimental group 3-2, the experimental group 2-2 takes the cooked glutinous rice flour to replace the maltodextrin, which easily causes the remains in pores on the surface of the spread object, making washing the object time-consuming and difficult. Therefore, the best formula of the product would not only depend on the drying time of the control groups 1 to 6, the drying time of the experimental groups 1 to 3, the drying time of the experimental groups 1-1 to 3-3 in the drying experiment, the time of starting dissolution of the control groups 1 to 6, the time of starting dissolution of the experimental groups 1 to 3, and the time of starting dissolution of the experimental groups 1-1 to 3-3, but also the using experience of customers, wherein the experimental group 1-1 is taken as, but not limited to, an embodiment of the present invention.

With the aforementioned design, the water-soluble adhesive mixture could imitate a cement and have the adhering function for users to apply on and adhere to the surface of the toys, so that the toys could be adhered together to form a toy model. As the water-soluble adhesive of the water-soluble adhesive mixture could dissolve in water, the water-soluble adhesive could be softened and dissolved when the water-soluble adhesive mixture is immersed in water, weakening the adhesion of the water-soluble adhesive mixture and allowing the model, which is made by adhering different toys together, to be disassembled easily. Additionally, the water-soluble adhesive mixture could be directly washed away with water and would not remain on the surface of the toys, maintaining the quality of the toys

Moreover, the compositions of the adhesive composition are non-toxic materials and do not cause skin irritation, thereby the adhesive composition is safe for children to use.

It must be pointed out that the embodiments described above are only some preferred embodiments of the present invention. All equivalent structures which employ the concepts disclosed in this specification and the appended claims should fall within the scope of the present invention.

What is claimed is:

1. An adhesive composition, comprising:
an organic adhesive material comprising a water-soluble adhesive and a starch, wherein a weight of the organic adhesive material accounts for 4 wt % to 70 wt % of an overall weight of the adhesive composition; and
a sand, wherein a weight of the sand accounts for 30 wt % to 96 wt % of the overall weight of the adhesive composition.

2. The adhesive composition as claimed in claim 1, wherein a weight of the water-soluble adhesive accounts for 2.5 wt % to 42 wt % of the overall weight of the adhesive composition, and a weight of the starch accounts for 1.5 wt % to 28 wt % of the overall weight of the adhesive composition.

3. The adhesive composition as claimed in claim 2, wherein the weight of the water-soluble adhesive accounts for 5 wt % to 10 wt % of the overall weight of the adhesive composition, and the weight of the starch accounts for 3 wt % to 7 wt % of the overall weight of the adhesive composition.

4. The adhesive composition as claimed in claim 1, wherein the water-soluble adhesive is a polyvinyl alcohol; a degree of hydrolysis of the water-soluble adhesive ranges between 85 mole % and 99.5 mole %, and a viscosity of the water-soluble adhesive at 25° C. ranges between 5 cps and 50 cps.

5. The adhesive composition as claimed in claim 4, wherein the water-soluble adhesive comprises a first hydrolyzed polyvinyl alcohol, a second hydrolyzed polyvinyl alcohol, and a third hydrolyzed polyvinyl alcohol; a degree of hydrolysis of the first hydrolyzed polyvinyl alcohol is larger than both a degree of hydrolysis of the second hydrolyzed polyvinyl alcohol and a degree of hydrolysis of the third hydrolyzed polyvinyl alcohol.

6. The adhesive composition as claimed in claim 5, wherein the degree of hydrolysis of the first hydrolyzed polyvinyl alcohol ranges between 98 mole % and 99.5 mole %, the degree of hydrolysis of the second hydrolyzed polyvinyl alcohol ranges between 86 mole % and 89 mole %, and the degree of hydrolysis of the third hydrolyzed polyvinyl alcohol ranges between 86 mole % and 89 mole %.

7. The adhesive composition as claimed in claim 5, wherein a viscosity of the first hydrolyzed polyvinyl alcohol is larger than a viscosity of the second hydrolyzed polyvinyl alcohol, and is smaller than a viscosity of the third hydrolyzed polyvinyl alcohol.

8. The adhesive composition as claimed in claim 7, wherein the viscosity of the first hydrolyzed polyvinyl alcohol at 25° C. ranges between 25 cps and 30 cps, the viscosity of the second hydrolyzed polyvinyl alcohol at 25° C. ranges between 5 cps and 6 cps, and the viscosity of the third hydrolyzed polyvinyl alcohol at 25° C. ranges between 44 cps and 50 cps.

9. The adhesive composition as claimed in claim 5, wherein a weight of the first hydrolyzed polyvinyl alcohol accounts for 1 wt % to 2 wt % of the overall weight of the adhesive composition, a weight of the second hydrolyzed polyvinyl alcohol accounts for 2.5 wt % to 5 wt % of the overall weight of the adhesive composition, and a weight of the third hydrolyzed polyvinyl alcohol accounts for 1.5 wt % to 3 wt % of the overall weight of the adhesive composition.

10. The adhesive composition as claimed in claim 1, wherein the starch comprises a pregelatinized starch, a natural starch, a dextrin, and a cooked glutinous rice flour, or a combination thereof.

11. The adhesive composition as claimed in claim 2, wherein the starch comprises a first starch and a second starch; the first starch comprises a maltodextrin, and the second starch comprises a pregelatinized corn starch; a content of the first starch is larger than a content of the second starch.

12. The adhesive composition as claimed in claim 11, wherein the starch further comprises a third starch comprising a pregelatinized tapioca starch; a content of the third starch is equal to the content of the first starch.

13. The adhesive composition as claimed in claim 2, wherein the starch comprises a first starch, a second starch, and a third starch; the first starch comprises a cooked glutinous rice flour, the second starch comprises a pregelatinized corn starch, and the third starch comprises a pregelatinized tapioca starch; a content of the first starch is smaller than both a content of the second starch and a content of the third starch, and the content of the second starch is equal to the content of the third starch.

14. The adhesive composition as claimed in claim 1, wherein the sand is a silica sand, and the weight of the sand accounts for 83 wt % to 92 wt % of the overall weight of the adhesive composition.

15. The adhesive composition as claimed in claim 1, wherein a grain size of the sand ranges between 70 mesh and 200 mesh.

16. The adhesive composition as claimed in claim 15, wherein the grain size of the sand ranges between 80 mesh and 120 mesh.

17. A water-soluble adhesive mixture, comprising:
an adhesive composition comprising an organic adhesive material and a sand, wherein the organic adhesive material comprises a water-soluble adhesive and a starch; a weight of the organic adhesive material accounts for 4 wt % to 70 wt % of an overall weight of the adhesive composition, and a weight of the sand accounts for 30 wt % to 96 wt % of the overall weight of the adhesive composition; and
an aqueous solution that is mixed with the adhesive composition to form a viscous mixture, wherein an addition of the aqueous solution is equal to 33 wt % to 99 wt % of the overall weight of the adhesive composition.

18. The water-soluble adhesive mixture as claimed in claim 17, wherein a weight of the water-soluble adhesive accounts for 2.5 wt % to 42 wt % of the overall weight of the adhesive composition, a weight of the starch accounts for 1.5 wt % to 28 wt % of the overall weight of the adhesive composition.

19. The water-soluble adhesive mixture as claimed in claim 18, wherein the weight of the water-soluble adhesive accounts for 5 wt % to 10 wt % of the overall weight of the adhesive composition, the weight of the starch accounts for 3 wt % to 7 wt % of the overall weight of the adhesive composition, and the weight of the sand accounts for 83 wt % to 92 wt % of the overall weight of the adhesive composition.

20. The water-soluble adhesive mixture as claimed in claim 18, wherein the starch comprises a first starch and a second starch; the first starch comprises a maltodextrin, and the second starch comprises a pregelatinized corn starch; a content of the first starch is larger than a content of the second starch.

21. The water-soluble adhesive mixture as claimed in claim 20, wherein the starch further comprises a third starch comprising a pregelatinized tapioca starch; a content of the third starch is equal to the content of the first starch.

22. The water-soluble adhesive mixture as claimed in claim 18, wherein the starch comprises a first starch, a second starch, and a third starch; the first starch comprises a cooked glutinous rice flour, the second starch comprises a pregelatinized corn starch, and the third starch comprises a pregelatinized tapioca starch; a content of the first starch is smaller than both a content of the second starch and a content of the third starch, and the content of the second starch is equal to the content of the third starch.

23. The water-soluble adhesive mixture as claimed in claim 17, wherein the water-soluble adhesive comprises a first hydrolyzed polyvinyl alcohol, a second hydrolyzed polyvinyl alcohol, and a third hydrolyzed polyvinyl alcohol; a weight of the first hydrolyzed polyvinyl alcohol accounts for 1 wt % to 2 wt % of the overall weight of the adhesive composition, a weight of the second hydrolyzed polyvinyl alcohol accounts for 2.5 wt % to 5 wt % of the overall weight of the adhesive composition, and a weight of the third hydrolyzed polyvinyl alcohol accounts for 1.5 wt % to 3 wt % of the overall weight of the adhesive composition.

24. The water-soluble adhesive mixture as claimed in claim 17, wherein the starch comprises a pregelatinized starch, a natural starch, a dextrin, and a cooked glutinous rice flour, or a combination thereof.

25. The water-soluble adhesive mixture as claimed in claim 17, wherein the water-soluble adhesive is a polyvinyl alcohol; a viscosity of the water-soluble adhesive at 25° C. ranges between 5 cps and 50 cps, and a degree of hydrolysis of the water-soluble adhesive ranges between 85 mole % and 99.5 mole %.

26. The water-soluble adhesive mixture as claimed in claim 25, wherein the water-soluble adhesive comprises a first hydrolyzed polyvinyl alcohol, a second hydrolyzed polyvinyl alcohol, and a third hydrolyzed polyvinyl alcohol; a degree of hydrolysis of the first hydrolyzed polyvinyl alcohol ranges between 98 mole % and 99.5 mole %, a degree of hydrolysis of the second hydrolyzed polyvinyl alcohol ranges between 86 mole % and 89 mole %, and a degree of hydrolysis of the third hydrolyzed polyvinyl alcohol ranges between 86 mole % and 89 mole %.

27. The water-soluble adhesive mixture as claimed in claim 26, wherein a viscosity of the first hydrolyzed polyvinyl alcohol at 25° C. ranges between 25 cps and 30 cps, a viscosity of the second hydrolyzed polyvinyl alcohol at 25° C. ranges between 5 cps and 6 cps, and a viscosity of the third hydrolyzed polyvinyl alcohol at 25° C. ranges between 44 cps and 50 cps.
